(19) United States
(12) Patent Application Publication
(10) Pub. No.: US 2025/0010799 A1
(43) Pub. Date: Jan. 9, 2025

(54) INTEGRATED CONNECTOR FILTER FOR TRUCK-TRAILER DATA COMMUNICATION

(71) Applicants: Gabriel Lepage, Royal Oak, MI (US); Troy Cooprider, White Lake, MI (US); John Kirwan, Troy, MI (US); Justin Sloan, Novi, MI (US); Grant Wheeler, El Paso, TX (US)

(72) Inventors: Gabriel Lepage, Royal Oak, MI (US); Troy Cooprider, White Lake, MI (US); John Kirwan, Troy, MI (US); Justin Sloan, Novi, MI (US); Grant Wheeler, El Paso, TX (US)

(21) Appl. No.: 18/764,636

(22) Filed: Jul. 5, 2024

Related U.S. Application Data
(60) Provisional application No. 63/525,649, filed on Jul. 7, 2023.
(60) Provisional application No. 63/560,373, filed on Mar. 1, 2024.

(51) Int. Cl. B60R 1/26; B60D 1/62; H04N 7/10; H04N 7/18

(52) U.S. Cl. CPC B60R 1/26; H04N 7/102; H04N 7/181; B60D 1/62

(57) ABSTRACT

An integrated connector filter for adapting a tractor or a trailer to communicate data over tractor/trailer cable includes a housing that provides first and second connectors that are in electrical communication with one another, the first connector is configured to be removably connected to a cable that electrically connects the tractor and the trailer to one another, the second connector is configured to be connected to one of the tractor and the trailer. A filter is arranged within the housing and electrically connected between the first and second connectors by at least one wire. A first filter connector is electrically connected to the filter and configured to carry a signal. The filter is configured to superimpose the signal onto the at least one wire and/or split off the signal from the at least one wire, and the first filter connector is configured to be electrically connected to a gateway on one of the tractor and the trailer.

### CROSS-REFERENCE TO RELATED APPLICATION

This application claims priority to Untied States Provisional Application No. 63/525,649 filed Jul. 7, 2023 and U.S. Provisional Application No. 63/560,373 filed Mar. 1, 2024.

### TECHNICAL FIELD

This disclosure relates to a data communications architecture suitable for use with a camera monitor system (CMS) used in a commercial truck, and in particular, to an integrated connector filter used to package various components of the communications architecture for use with existing tractor/trailer fleets.

### BACKGROUND

Data transfer between a tractor and a trailer is an emerging trend with limited existing application. It is currently accomplished via its own connection between the tractor and trailer. This connection can be either wired, or wireless.

Existing wired connections require adding a separate connection system between the tractor and the trailer (receptacles on tractor and trailer and a cable connection). This requires that the truck drivers perform an additional, separate action to accomplish the connection.

Wireless connections can suffer from reliability in data transfer between the trailer and the cab. Additionally, the wireless pairing between tractor and trailer upon hook-up can be time-consuming and difficult to ensure that the tractor is paired with the right trailer in a yard that would contain multiple wireless-equipped trailers.

Existing truck and trailer electrical connections provide DC power and very low frequency signals from the truck to the trailer. For example, a standard J560 connection has seven pins which carry aux power, ground, reverse lights, tail lights, right turn (brake), left turn (brake) and electric brakes. Many trucks and trailers already include standard J560 female connectors mounted thereto.

### SUMMARY

Disclosed herein are several embodiments of an integrated connector filter for providing data communication between a truck and a trailer over a standard electrical connection without requiring significant additional steps by the driver. The integrated connector filters each receive data over a gateway and superimpose that data as low-amplitude, high-frequency signals onto at least one of a plurality of wires of the standard connector and cable. Each integrated connector filter also splits off the high-frequency signals sent by the other integrated connector filter and sends that data to a gateway on its associated truck or trailer.

In one embodiment, the integrated connector filter includes a housing that is permanently secured to the existing electrical socket in each of the truck and the trailer. The housing of each integrated connector filter provides a standard connector for receiving a connector of a standard electrical cable for connecting the truck to the trailer.

In another embodiment, an integrated connector filter is integrated with each of the connectors of an electrical cable for connecting the truck and the trailer.

In another embodiment, a housing of an integrated connector filter is mounted to each of the truck and the trailer adjacent the standard connector. The standard electrical cable is connected between the housings of the integrated connector filters on the truck and the trailer. The integrated connector filter passes the standard DC and low-frequency signals through a jumper to the nearby standard connector.

In another exemplary embodiment, an integrated connector filter for adapting a tractor or a trailer to communicate data over tractor/trailer cable includes a housing that provides first and second connectors that are in electrical communication with one another, the first connector is configured to be removably connected to a cable that electrically connects the tractor and the trailer to one another, the second connector is configured to be connected to one of the tractor and the trailer. A filter is arranged within the housing and electrically connected between the first and second connectors by at least one wire. A first filter connector is electrically connected to the filter and configured to carry a signal. The filter is configured to superimpose the signal onto the at least one wire and/or split off the signal from the at least one wire, and the first filter connector is configured to be electrically connected to a gateway on one of the tractor and the trailer.

In a further embodiment of any of the above, the integrated connector filter includes a PCB that includes the filter. The housing includes first and second housing portions. The PCB is mounted to one of the first and second housing portions.

In a further embodiment of any of the above, the integrated connector filter includes a cover that is arranged between the first and second housing portions. The cover is secured to the one of the first and second housing portions over the PCB to seal the PCB.

In a further embodiment of any of the above, the integrated connector filter includes a wiring harness that is arranged within the housing and electrically connects the first and second connectors to one another and to the filter via the PCB.

In a further embodiment of any of the above, the integrated connector filter includes a first data connector that is provided on the PCB or the housing. The first data connector is electrically connected to the filter. The wiring harness includes the at least one wire terminating in a second data connector that is electrically connected to the first data connector. The filter is electrically interposed between the first data connector and the first filter connector.

In a further embodiment of any of the above, the wiring harness includes first and second pinned connectors that are removably connected respectively to a backside of the first and second connectors.

In a further embodiment of any of the above, the first connector is a female connector and the second connector is a male connector.

In a further embodiment of any of the above, the first and second connectors are each 7-pin connectors.

In a further embodiment of any of the above, the 7-pin connectors are compatible with standard J560 connectors.

In a further embodiment of any of the above, the first connector is removably secured and electrically coupled to the housing.

In a further embodiment of any of the above, the first connector is a standard 7-pin female J560 connector.

In a further embodiment of any of the above, the second housing portion includes an opening that is configured to receive gateway wires for connection to the first filter connector.

In a further embodiment of any of the above, a tractor that includes the integrated connector filter includes a CMS that includes first and second rear-facing cameras, at least one display, and a CMS controller that is in communication with the first and second rear-facing cameras and the at least one display. The CMS controller is configured to provide video feeds from the first and second rear-facing cameras to the at least one display. Vehicle controls are configured to operate trailer components. A wiring harness is electrically connected to the vehicle controls and terminates at a bulkhead connector. The integrated connector filter is electrically connected to the bulkhead connector. Another controller includes at least one processor and the gateway, the other controller is configured to receive a sensor signal from a sensor on the trailer and to receive control signals for controlling the trailer components. The at least one processor is configured to transform the sensor signal for transmission over the wiring harness with at least one of the plurality of control signals using common wires within the wiring harness.

In a further embodiment of any of the above, a trailer includes multiple trailer components, a sensor that is configured to generate a sensor signal, a wiring harness that is electrically connected to the multiple trailer components and the sensor, the wiring harness terminating at a bulkhead connector, the integrated connector filter is electrically connected to the bulkhead connector. A controller includes at least one processor and the gateway. The controller is configured to receive the sensor signal from the sensor and to receive control signals for controlling the trailer components. The at least one processor is configured to transform the sensor signal for transmission over the wiring harness with at least one of the plurality of control signals using common wires within the wiring harness.

In a further embodiment of any of the above, a method of installing the integrated connector filter includes the steps of: a) removing a standard connector from a tractor or trailer socket at a bulkhead, b) connecting a second filter connector from the tractor or trailer to the first filter connector, c) inserting the first connector into the tractor or trailer socket, d) tightening fasteners to secure the housing to the tractor or trailer socket, and e) inserting a cable into the second connector to couple the tractor and trailer to one another.

These and other features of the present invention can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1 is a high-level schematic of one embodiment of an integrated connector filter for use with a tractor.

FIG. 2 is a high-level schematic of one embodiment of an integrated connector filter for use with a trailer.

FIG. 3 is a more detailed schematic of the integrated connector filters of FIGS. 1 and 2 mounted to a truck and trailer.

FIG. 4 is a front perspective view of one example implementation of the integrated connector filter.

FIG. 5 is a rear perspective view of the integrated connector filter of FIG. 4.

FIG. 6 is a schematic of other example integrated connector filters connecting the truck and the trailer.

FIG. 7 is another schematic of example integrated connector filters connecting the truck and the trailer.

FIG. 8 shows a perspective view of the integrated connector filter mounted to a trailer.

FIGS. 9A-9C respectively illustrate a front perspective view, a rear perspective view and a top view of another example integrated connector filter.

FIG. 10 is an exploded view of the integrated connector filter shown in FIGS. 9A-9C.

FIG. 11 is a rear view of the integrated connector filter shown in FIG. 10.

FIG. 12A is a schematic of a trailer camera communications system in which packaging details of the integrated connector filter are omitted.

FIG. 12B is a schematic of an alternate trailer communications system in which packaging details of the integrated connector filter are omitted.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

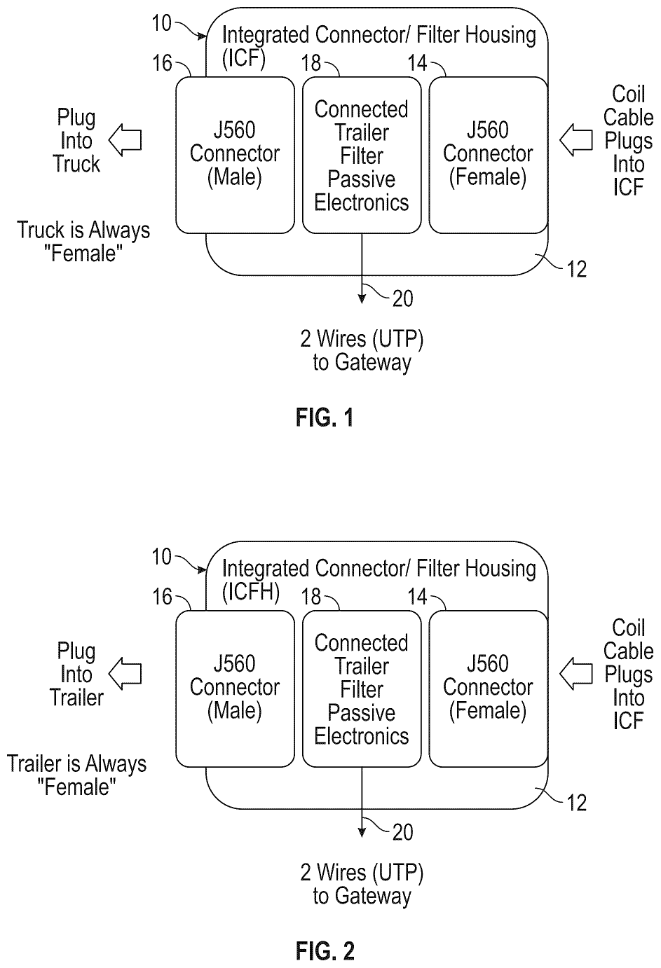

FIG. 1 shows a high-level schematic of one embodiment of an integrated connector filter 10 for use in a data communications system between a tractor and trailer. Examples of such systems are disclosed in PCT/US2022/034710, entitled “TRAILER CAMERA COMMUNICATIONS SYSTEM”, published on Dec. 29, 2022, and U.S. patent application Ser. No. 18/657,104 entitled “TRAILER CAMERA COMMUNICATIONS SYSTEM”, filed on May 7, 2024, both of which are incorporated by reference in their entirety. The integrated connector filter 10 includes a housing 12 that provides both packaging and functionality that provides a robust, reliable approach to retrofitting existing vehicles with the data communications system. A first and second connector (e.g., female connector 14 and a male connector 16) are integrated at opposite sides of the housing 12. A filter 18 is interposed between at least one (and preferably two) of a plurality of electrical paths from the female connector 14 to the male connector 16. Data is sent to and received from the filter 18 via wires 20.

Throughout this disclosure, seven-wire tractor/trailer wiring harnesses and 7-pin J560 connectors are referenced; however, it should be understood that the scope of the invention is not limited to a certain number of wires, a certain connector configuration or a certain standard. Other examples of wiring schemes and standards include 15-pin systems (ISO 12098) 13-pin systems (ISO 11446), 7-pin systems (ISO 1185, ISO 7638-1, ISO 7638-2, ISO 3731, ISO 1724, ISO 3732). Rather, the disclosure relates to a system and method that enables affordable, reliable wired data communication over existing wiring and connector standards common in the industry (presently or in the future) with limited modifications. This encourages more widespread, faster adoption of the technology of existing tractor/trailer fleets until new standards are developed.

FIG. 1 illustrates the integrated connector filter 10 for connection to a truck. As shown in FIG. 2, an identical integrated connector filter 10 may also be connected to the trailer. This configuration enables existing tractors and trailers connectors (both have female connectors) to be retrofitted while maintaining compatibility with existing coil cables (e.g., SAE J2394, which have male connectors at each opposing end).

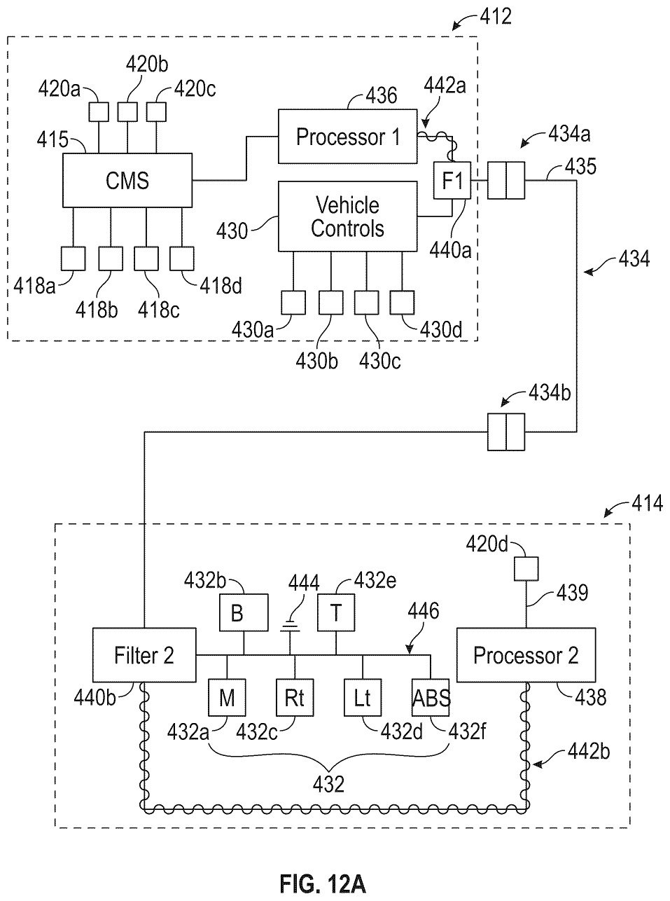

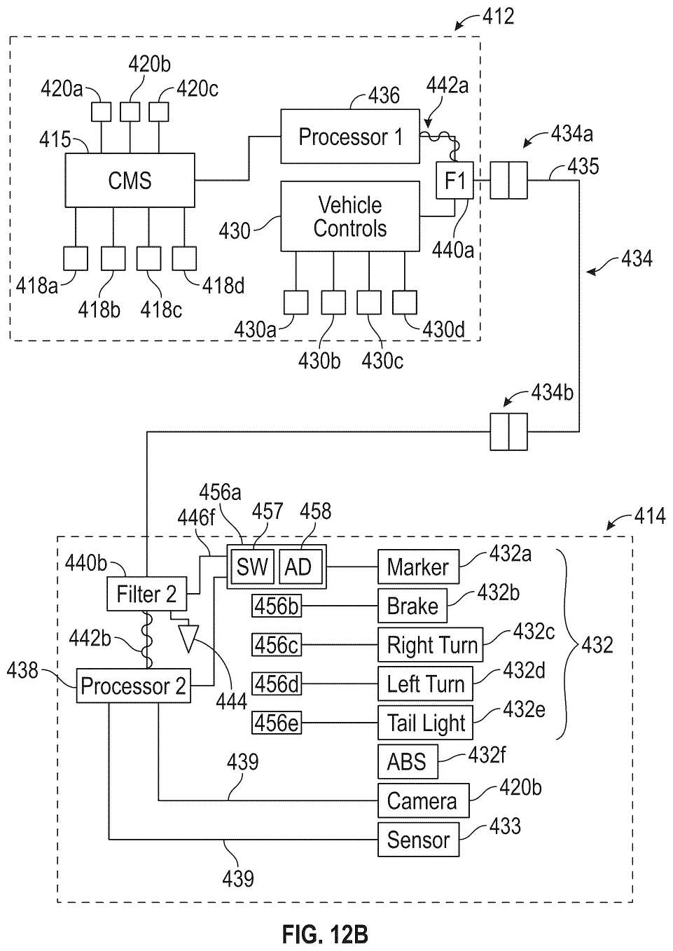

Example communications architectures in which the disclosed integrated connector filters are used are illustrated in FIGS. 12A and 12B. Other architectures may also be used. A tractor 412 includes a camera monitor system (CMS) 415 with rear-facing side cameras and/or other cameras (e.g., 420a-420c) and associated displays (e.g., 418a-418d) for indirect viewing of legally prescribed views similar to those provided side-mounted rearview mirrors.

Referring to FIG. 12A, the trailer 414 includes trailer components 432, such as a marker light 432a, a brake light 432b, a turn signal (right, 432c; left, 432d), a tail light 432e, and an anti-lock braking system component 432f. Each of the trailer components 432a-432f (collectively, trailer components 432) are responsive to a control signal from one or more vehicle controls 430, e.g., switches 430a-430d. The trailer components 432 on the trailer 414 are connected to the tractor 412 by a typical wiring harness 434. As an example, a standard 7-pin jumper cable 435 (e.g., J2394) interconnects the tractor 412 and trailer 414 at connectors 434a, 434b, which are of a typical configuration. As a result, the disclosed system can be used with the existing ubiquitous trailer wiring harnesses and electrical connectors in the industry.

There are various ground wires 444 in the system, only some of which are shown. Wires within a common wiring harness 434 are unshielded copper wire, typically multiple copper wire strands covered in a polymer insulation, but the wires can be shielded. For a standard 7-pin arrangement, a common ground 444 is provided, and control signals for the marker light 432a, the brake light 432b the turn signal (right, 432c; left, 4432d), the tail light 432e, and auxiliary power 432f (which may be used, for example, for the anti-lock braking system component), are respectively sent over power wires 446a-446f. The invention is not limited to any particular pin arrangement. For example, the pin arrangement of SAE J560 and ISO1185 could be used.

A sensor 420d, such as camera 420d with an image capture unit that generates a sensor signal, may need to be send its signal at a high transmission rate. The disclosed integrated connector filter 10 accomplishes this transmission without the need for dedicated wiring running from the rear of the trailer 414 all the way to the tractor 412, which greatly simplifies installation and reduces cost. Desired sensor signal transmission is achieved over the very same power wires on the trailer 414 used to transmit control signals to the trailer components 432.

The tractor 412 has a first controller 436 that transmits the received sensor signal to the CMS 415 for display to the operator. A second controller 438 is arranged on the trailer 414 and interconnected between the camera 420d (or sensor) and the wiring harness 434. Each of the first controller 436 and the second controller 438 includes at least one processor and associated electronic storage storing instructions, which when executed by the associated controller perform the functions as described herein. Additionally, each of the first controller 436 and second controller 438 include a plurality of inputs and outputs having any necessary additional hardware for receiving and sending the signals, information and commands as described herein.

The second controller 438 is configured to transform the sensor signal for transmission over the wiring harness 434 with the control signal using wires that are common with the wiring harness wires used to carry control signals to the trailer components 432. Said another way, several of the existing wires, e.g., a power wire and a ground wire, have a dual purpose: carrying a control signal and the sensor signal. An example chipset that may be used is available as VA6000 from Valens Semiconductor Ltd., although it should be understood that other processors can be used and fall within the scope of the disclosed system. Another example chipset is the DCB1M available from Yamar Electronics Ltd. The example chipsets each include at least one processor for transforming the signal for transmission over the wiring harness, along with suitable electronic storage storing instructions, which when executed by the at least one processor cause the chipset to perform the transformation of the sensor signal.

Noise is generated by the trailer components 432, such that a usable image signal may not be provided to the first and second controllers 436, 438. So, first and second filters 440a, 440b are used at the signal tap locations, for example, respectively in the tractor and trailer wiring harness to filter out noise prior to transmission to the processors. Each of the filters 440a, 440b are connected to its respective first and second controller 436, 438 by an unshielded twisted pair of wires 442a, 442b. The twisted wire pairs are unshielded copper wire, typically multiple copper wire strands covered in a polymer insulation. Alternatively, the wires 442a, 442b could be shielded.

The second controller 438 includes an input, and the camera 420d is connected to the input by a high-speed transmission cable 439, such as an ethernet cable. The second controller 438 may be provided by a chipset that includes a processor and an encoder, which is configured to embed the sensor signal into the control signal for transmission along the power wire(s) to the first controller 36. Additional electrical devices may be connected to multiple inputs, if provided on the processor. The other inputs may accommodate, for example, IRLEDs associated with the camera 420d. The chipset may include a multiplexer configured to combine the inputs to provide the sensor signal as an output of the sensor along with outputs from the electrical devices.

The first controller 436 includes a decoder and a demultiplexer, which can be provided on the same chipset or separately, that are configured to isolate the sensor signal from the control signal. The decoder is provided by at least one of hardware and software.

At least one of the first and second controllers 436, 438 may be configured to perform pulse amplitude modulation to reduce noise in the control signal over the common power wires.

Although the sensor is described above as a camera 420d, it should be understood that other sensors may also be used in addition to or instead of a camera, such as a radar sensor, a lidar sensor, an infrared sensor and an ultrasonic sensor. In the case of a camera, it is desirable to transmit the sensor signal between the first and second controllers 436, 438 and on to the CMS 415 over the common wires at a speed of at least 15 Mb/s. Compressing the sensor signal could result in undesired latency. The disclosed system is capable of achieving the desired transmission rate, without compression, with the minimal latency needed in a CMS system, i.e., less than 200 ms.

FIG. 12B provides an alternative trailer communication system. In this example, the tractor 12 and the hardware components therein are the same as they were in FIG. 12A, although they are not required to be.

The trailer 414 again includes the second filter 440b and the second controller 438. As will be described below, the second controller 38 may include additional hardware and is programmed differently from how it was programmed in the FIG. 12A example.

The trailer 414 includes trailer components 432 similar to those in FIG. 12A, such as a marker light 432a, brake light 432b, turn signals (right turn 432c; left turn 432d), and a tail light 432e. Each of the trailer components 432a-432e (collectively, trailer components 432) is responsive to a control signal from one or more vehicle controls 430, e.g., switches 430a-430d. An anti-lock braking system component 432f or other accessory may also be installed on the trailer 414. The camera 4420d and/or a sensor 433 may also be installed on trailer 14.

The tractor 412 is connected to the trailer 414 by a typical wiring harness 434. As an example, a standard 7-pin jumper cable (e.g., J2394) 435 interconnects the tractor 412 and trailer 414 at connectors 434a, 434b, which may be of a typical configuration, in which case, the disclosed system could be used with the existing ubiquitous trailer wiring harnesses and electrical connectors in the industry.

There are various ground wires 444 in the system, only some of which are shown. Wires within a common wiring harness 434 are unshielded (or unshielded) copper wire, typically multiple copper wire strands covered in a polymer insulation. For a standard 7-pin arrangement, a common ground 444 is provided, and control signals for the marker light 432a, brake light 432b, turn signals (right, 432c; left, 432d), and tail light 432e are sent over power wires 446a-446e, respectively. Auxiliary power (i.e. always on) is provided over wire 446f.

Again, the camera 420d has an image capture unit that generates a sensor signal that must be sent at a high transmission rate. The camera 420d may be a visible light digital camera generating a live video signal. Sensor 433 may be a digital video camera other than a visible light camera, generating a sensor signal, such as a live video signal. Sensor 433 may be a radar sensor, a lidar sensor, an infrared sensor, an ultrasonic sensor or other sensor other than a visible light sensor. The sensor signal from sensor 433 must also be sent at a high transmission rate. Each sensor signal transmission is achieved over a different subset of the very same wires 446 on the trailer 414 normally used to transmit control signals and/or power from the vehicle controls 430 to the trailer components 432. The first controller 436 in the tractor 412 receives the sensor signal(s) (from camera 420d and/or sensor 433) over the wire harness 434 and transmits the received sensor signal(s) to the CMS 415 for display to the operator.

The second controller 438 includes at least one input, such as a network connection, to which the camera 420d and sensor 433 are connected by a high-speed transmission cable 439, such as an ethernet cable. The second controller 438 may have a pair of inputs, one for each of the camera 420d and the sensor 433 through which the second controller 438 receives the sensor signals.

The second controller 438 may include at least one chipset that includes a processor and an encoder, which is configured to embed the sensor signal(s) into the control signal for transmission along the power wire(s) to the first controller 436. Additional electrical devices may be connected to multiple inputs, if provided on the processor. The other inputs may accommodate, for example, IRLEDs associated with the camera 420d. Each chipset may include a multiplexer configured to combine the inputs to provide the sensor signals as an output of the sensor along with outputs from the electrical devices.

The first controller 436 includes a decoder and a demultiplexer, which can be provided on the same chipset or separately, that are configured to isolate the sensor signal from the control signal. The decoder is provided by at least one of hardware and software.

At least one of the first and second controllers 436, 438 may be configured to perform pulse amplitude modulation to reduce noise in the control signal over the common power wires.

A plurality of switch assemblies 456a-e selectively provide power from the auxiliary power wire 446f (optionally after passing through the second filter 440b) to each of the trailer components 432a-e, respectively.

Each of the plurality of switch assemblies 456a-e includes a switch 457 selectively providing power from the auxiliary power wire 446f to the associated one of the trailer components 432a-e (only the connections to one of the switch assemblies 456a-e is illustrated for clarity).

Each switch assembly 456a-e further includes an analog-to-digital converter and/or current sensor 58 measuring the current being provided to the associated trailer component 432a-e. The auxiliary power 446f may also be provided from the second filter 440b to the camera 420b and sensor 433.

In this embodiment, the second controller 438 receives the control signals in the wiring harness 434 intended for each of the trailer components 432 (or a subset thereof), the camera 420d, and the sensor 433. As shown, the second controller 438 may receive these signals from the filter 440b (which may filter each wire independently). Appropriate hardware in the second controller 438 converts the control signals in the wiring harness 434 to a suitable signal for the at least one processor in the second controller 438.

Each of the plurality of switch assemblies 456a-e is in communication with the second controller 438 (again only one connection between the second controller 438 and the switch assemblies 456a-e is illustrated). The second controller 38 is programmed to send commands to control each switch 457 to open or close based upon the control signals received on wires 446a-e from vehicle controls 430. Each sensor 458 monitors current being provided to the respective trailer component 432 and reports the status or any anomalies (e.g. light out) back to the second controller 438, which in turn may report such conditions back to the first controller 436 to alert the driver (e.g. via the CMS 415 or other display/alerts).

For example, if the second controller 438 receives an “on” command on the marker light wire 446a, then the second controller 438 sends a command to switch 457 within switch assembly 456a to switch on and provide power from wire 446f to the marker 432a. As it does, the sensor 458 monitors the current level provided from switch assembly 456a to the marker 432a. If the marker 432a light is out or damaged, the sensor 458 will detect the low current or lack of current and send an alert signal to the second controller 438. The other switch assemblies 456b-e would work similarly with their respective trailer components 432b-e.

The switch assemblies 456a-e are preferably mounted in the trailer closer to the second controller 438 than to the respective trailer components 432 to which they are connected. In another example, the switch assemblies 456a-e may be mounted in the trailer proximate the second controller 438 (e.g. in a common housing or on a common mounting surface), in which case minimal modification or redesign of any existing trailer 14 would be required.

Alternatively, the switch assemblies 456a-e may be mounted in the trailer closer to the respective trailer components 432 to which they are connected than to the second controller 438. In another example, each switch assembly 456a-e can be mounted proximate its respective trailer component 432 (e.g. a common housing or common mounting surface).

Alternatively, some combination of mounting locations can be used. For example, at least one of the switch assemblies 456-e can be proximate the second controller 438 and at least one of the switch assemblies 456a-e can be proximate its respective trailer component(s) 432.

As before, the second controller 438 is also configured to transform the sensor signal(s) (from camera 420d and/or sensor 433) for transmission over the wiring harness 434 with the control signal using wires that are common with the wiring harness wires intended to carry control signals to the trailer components 432. Again, an example chipset that may be used is available as VA6000 from Valens Semiconductor Ltd., although it should be understood that other processors can be used and fall within the scope of the disclosed system. Another example chipset is the DCB1M available from Yamar Electronics Ltd.

Noise may be generated by the vehicle controls 430 and/or the trailer components 432, such that a usable image signal may not be provided to the first controller 436 and the second controller 438. Therefore, the first filter 440a and the second filter 440b are used at the signal tap locations, for example, respectively in the tractor and trailer wiring harness 434 to filter out noise prior to transmission to the processors. Each of the filters 440a, 440b may be connected to its respective first and second controller 436, 438 by an unshielded twisted pair of wires 442a, 442b. The twisted wire pairs are unshielded copper wire, typically multiple copper wire strands 448 covered in a polymer insulation 450. Alternatively, the wires 442a, 442b could be shielded.

Returning to FIGS. 1 and 2, in one example, the female connector 14 and the male connector 16 are standard female and male J560 connectors, respectively. The filters 18 each receive data from a gateway via the wires 20 and superimpose that data as low-amplitude, high-frequency signals onto at least one of a plurality of wires of the standard connector and cable (again, such as the J560 standard connectors and cables). Each filter 18 also splits off the high-frequency signals sent by the other integrated connector filter 10 and sends that data to a gateway on its associated truck or trailer.

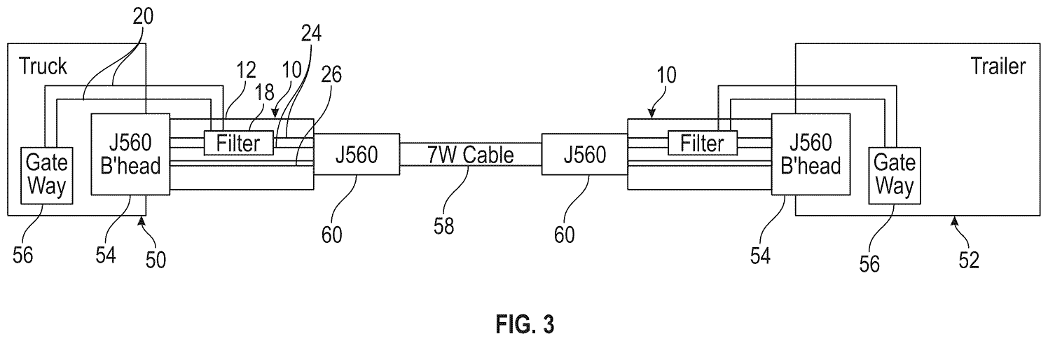

FIG. 3 shows a more detailed schematic of the integrated connector filters 10 of FIGS. 1 and 2 mounted to a bulkhead (standard female) connector 54 of a truck 50 and a bulkhead (standard female) connector 54 of a trailer 52. A standard electrical cable 58 having a standard male connector 60 at each end may be used to connect the integrated connector filter 10 of the truck 50 to the integrated connector filter 10 of the trailer. Again, in this example the standard female connector 54 and standard male connector 60 are J560 connectors, which have seven pins, and the standard electrical cable 58 is J560 cable with seven wires therein.

In this example, the electrical path between the male connector 60 of the standard electrical cable 58 and the standard female connector 54 through the housing includes two electrical paths 24 to which the filter 18 is connected. The filter 18 is configured to superimpose high-frequency, low-amplitude data signals onto the two electrical paths 24 based upon signals received over the wires 20 from the gateway 56. The filter 18 is also configured to split off high-frequency, low-amplitude data signals received on the two electrical paths 24 and send corresponding signals over the wires 20 to the gateway 56. The wires 20 may be an untwisted pair. The filter 18 provides proper isolation of the transmitted data signal between the gateway modules and provides proper impedance balance to the electrical circuit.

The remaining electrical paths 26 may simply pass through the housing 12. In this example, i.e. implemented using J560, there would be five such remaining electrical paths 26. The two electrical paths 24 (after the filter 18) and the remaining electrical paths 26 are passed to the male connector 16 of the integrated connector filters 10 and connected to the standard female connector 54 on the truck 50 or trailer 52. The DC or low frequency signals of the two electrical paths 24 simply pass through the filter 18.

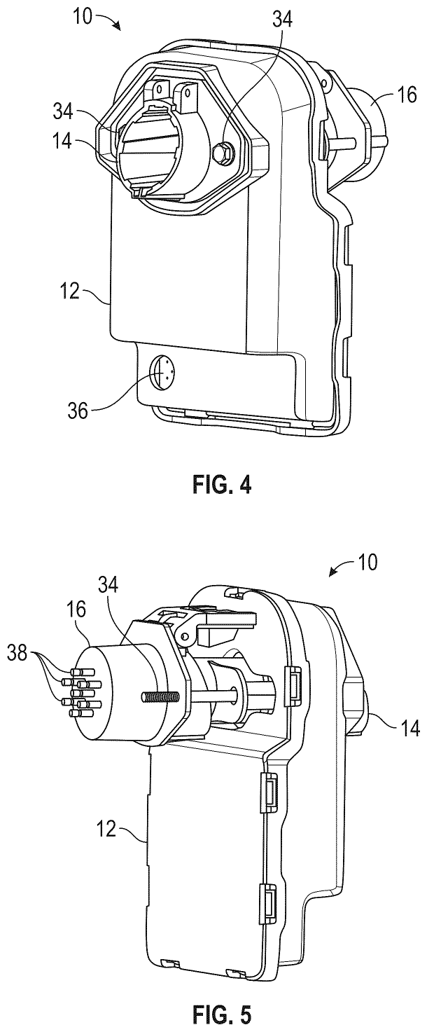

FIG. 4 is a front perspective view of one possible implementation of the integrated connector filter 10. The integrated connector filter 10 includes the housing 12, which may be a hard plastic or metal. The female connector 14 is mounted to one side of the housing 12 and the male connector 16 is mounted to an opposite side of the housing 12. Again, in the illustrated example, the female connector 14 and the male connector 16 are female and male standard J560 connectors, respectively. Other standards could also be implemented.

Fasteners 34, such as bolts, extend through the female connector 14, the housing 12, and the male connector 16 and are used to secure the integrated connector filter 10 to the truck 50 or trailer 52 (FIG. 2). The integrated connector filter 10 would be permanently connected to the truck 50 or trailer 52, at least as far as the driver is concerned (i.e. other than for repair or replacement of the integrated connector filter 10). An opening 36 (or connector) for passing the wires 20 (FIG. 2) is provided through housing 12.

FIG. 5 is a rear perspective view of the integrated connector filter 10 of FIG. 4. As shown, the male connector 16 in this case has seven pins 38 providing the seven electrical paths from the female connector 14 through the integrated connector filter 10.

Again, referring to FIG. 2, in use one integrated connector filter 10 would be permanently connected to the truck 50 and one integrated connector filter 10 would be permanently connected to the trailer 52. The wires 20 would be permanently connected to the gateway 56. When connecting the truck 50 to the trailer 52, the driver still only needs to connect the standard electrical cable 58 using the same method performed previously. However, the truck 50 and trailer 52 can send high speed data to one another over the standard electrical cable 58. For example, a video camera (or other sensor(s)) on the trailer 52 can provide a video feed to the gateway 56 on the trailer 52 which is then superimposed on the two carrier DC/low frequency signals of the J560 standard by the filter 18. These signals are carried over the standard electrical cable 58 and then split off by the filter 18 on the truck 50 and provided to the gateway 56 on the truck 50. The gateway 56 may then provide this video feed to the driver, such as via a display and/or analyze the video feed.

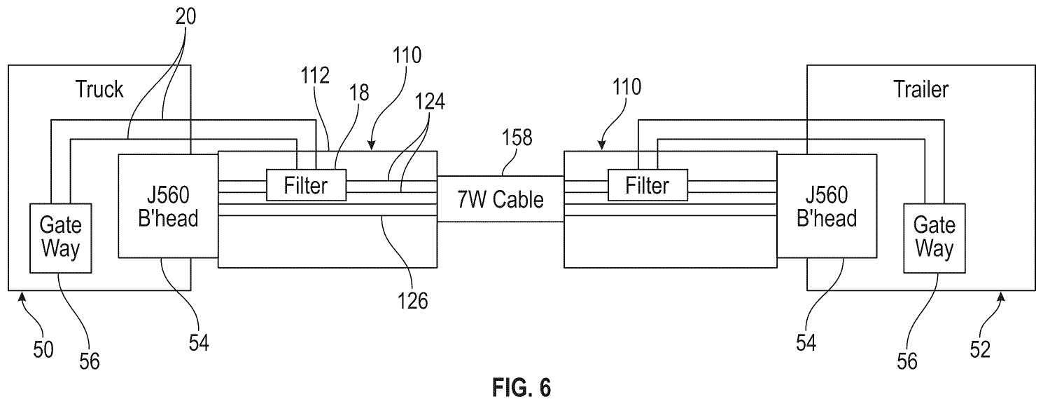

FIG. 6 is a schematic of integrated connector filters 110 according to a second embodiment connecting the truck 50 and the trailer 52. Again, the truck 50 and the trailer 52 each have a standard female connector 54 mounted thereto and a gateway 56 sending and receiving data signals via the filter 18 and wires 20.

In this embodiment, the integrated connector filter 110 is included at each end of a cable 158. The integrated connector filters 110 each include a standard male connector for connecting to the standard female connectors 54. Again, two electrical paths 124 pass through the filter 18, which operates as before. The two electrical paths 124 (after the filter 18) and the remaining electrical paths 126 are passed to the standard female connector 54 on the truck 50 or trailer 52.

In this embodiment, an additional connection of the wires 20 at the truck 50 and at the trailer 52 would also need to be made. The two wires 20 and the housing 112 would be provided with complementary connectors to facilitate the connection. Otherwise, in use, the truck 50 and the trailer 52 and integrated connector filters 110 would operate the same as in the first embodiment to communicate data between the truck 50 and the trailer 52.

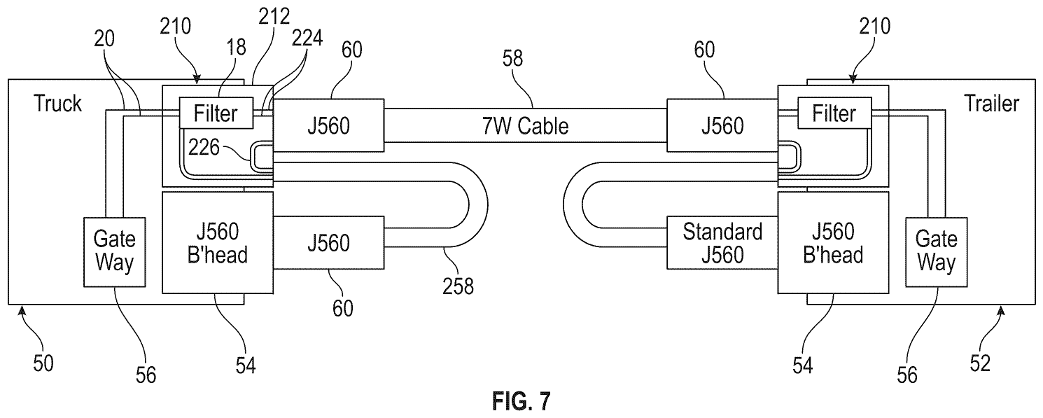

An integrated connector filter 210 according to a third embodiment is shown schematically in FIG. 7. Again, the truck 50 and the trailer 52 each have a standard female connector 54 mounted thereto and a gateway 56 again sending and receiving data signals via the filter 18 and wires 20.

In this embodiment, one integrated connector filter 210 is mounted to the truck 50 and the trailer 52 adjacent the standard female connector 54. The integrated connector filter 210 includes a housing 212 having a standard female connector integrated therewith. The standard electrical cable 58 with standard male connector 60 connects to each integrated connector filter 210. Again, two electrical paths 224 pass through the filter 18, which sends and receives data signals via the wires 20 to and from the gateway 56. The two electrical paths 224 and the remaining electrical paths 226 are connected to a jumper 258 which terminates in a standard male connector 60 which is connected to the standard female connector 54 on the truck 50 (or trailer 52). The jumper 258 stays in place connecting the integrated connector filter 210 to the standard female connector 54. Therefore, the driver only needs to connect the standard electrical cable 58 from the integrated connector filter 210 on the truck 50 to the integrated connector filter 210 on the trailer 52. The truck 50 and the trailer 52 can then communicate as before.

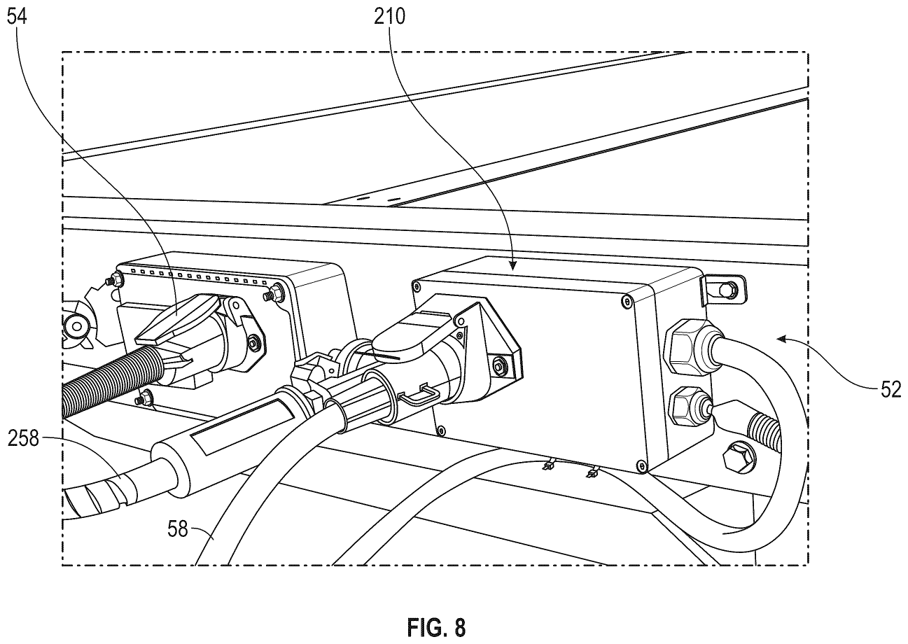

FIG. 8 shows a perspective view of the integrated connector filter 210 mounted to a trailer 52. The standard electrical cable 58 is connected to the integrated connector filter 210. The jumper 258 connects from the integrated connector filter 210 to the standard female connector 54 on the trailer 52.

It should be noted that the integrated connector filter 10 of the first embodiment could be implemented on one of the truck 50 and the trailer 52, while the integrated connector filter 210 of the third embodiment is implemented on the other of the truck 50 and the trailer 52. A standard electrical cable 58 could still connect the two and provide data communication therebetween.

It would also be possible to implement the cable 158 of the second embodiment with one standard male connector 60 at one end and one integrated connector filters 110 at the other end, if it were standardized that either trucks 50 or trailers 52 (but not both) were provided with either the first or third embodiment integrated connector filter 10, 110.

A typical tractor and trailer each include a wiring harness that terminates in a standard electrical socket. A standard connector (e.g., J560) is removably received in this socket, and the standard coil cable is connected between these standard tractor and trailer connectors to electrically connect the tractor and trailer to one another. This has become a common design in fleet vehicles because the standard connectors can wear out or become damaged, requiring replacement by the operator or service technician.

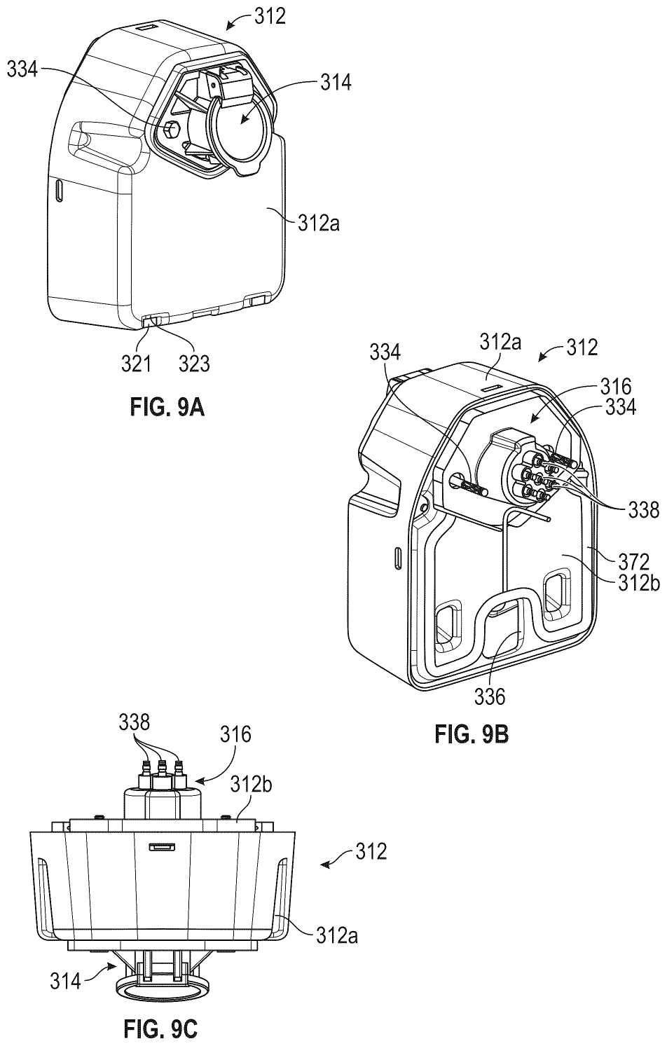

To simplify retrofitting of existing fleet vehicles, the disclosed integrated connector filter may be designed to replace (i.e., be swapped out for) the standard connector (e.g., J560) that plugs into the tractor's or trailer's wiring harness socket and provides the connection for the standard coil cable. This greatly reduces installation time. FIGS. 9A-11 illustrate another example integrated connector filter 310 for use in communicating a signal between a tractor and a trailer over a standard J560 cable. The integrated connector filter 310 includes a housing 312 provided by first and second housing portions 312a, 312b, which respectively support a standard 7-pin female connector 314 and a standard 7-pin male connector 316 having pins 338 configured to be received in a standard socket (e.g., Phillips QCS2).

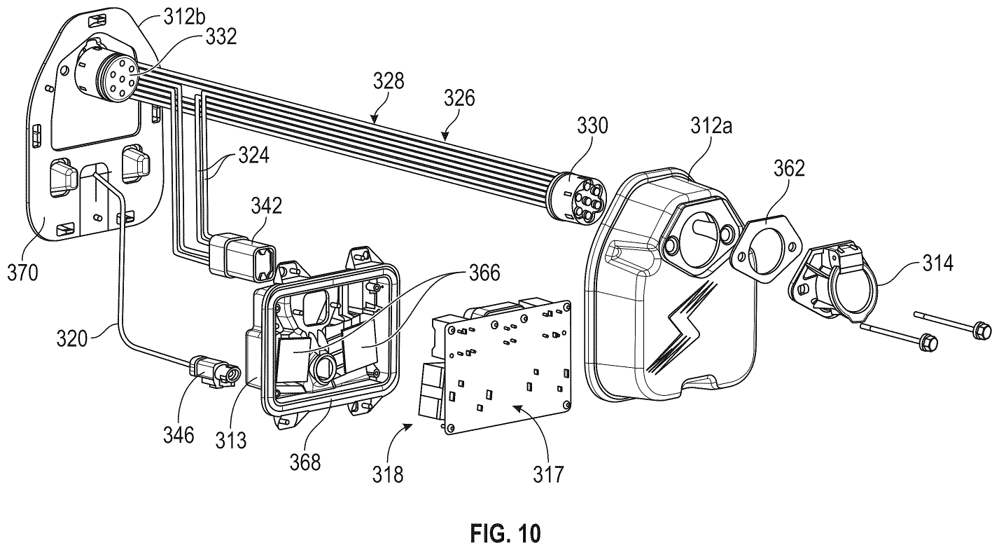

As shown in the example illustrated in FIG. 10, the female and male connectors 314, 316 are electrically connected to one another via a wiring harness 326 arranged within the housing 312. The wiring harness 326 includes first and second 7-pin connectors 330, 332 at opposing ends that are respectively electrically connected to the female and male connectors 314, 316. In the example, the first connector 330 removably mates with the pins (male side) on the back side of the female connector 314, which enables the standard female connector 314 to be removed in the case of damage. A gasket 362 provides a water-tight seal between the first housing portion 312a and the female connector 314. The second connector 332 may be a separate, discrete connector or integrated with the second housing portion 312b. The male connector 316 may also be integrated with the second housing portion 312b, further simplifying assembly and reliability of the connections.

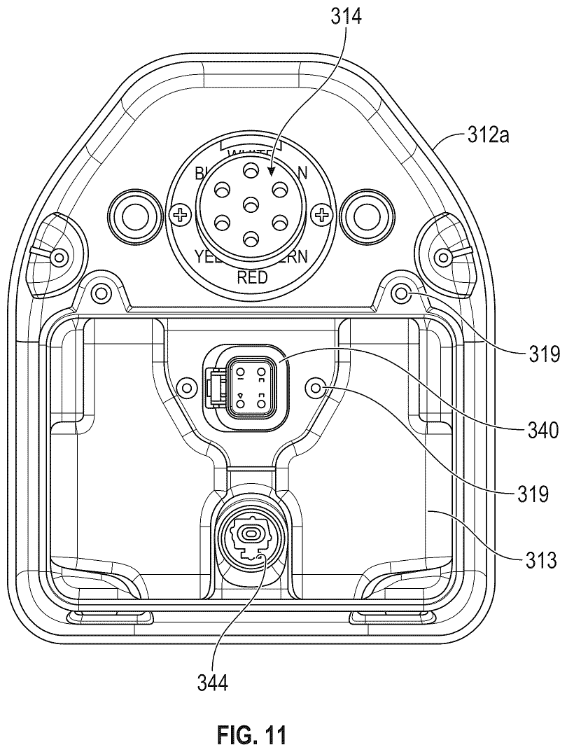

Referring to FIGS. 10 and 11, the filter 318 is mounted to a printed circuit board (PCB) 317, which is mounted to one of the first and second housing portions 312a, 312b. In the example, the controller/processor and gateway are not provided on the PCB 317 within the housing 312 and are located in closer proximity to the CMS (for tractor-mounted integrated connector filter) or sensor (for trailer-mounted integrated connector filter). In one disclosed embodiment, the PCB 317 only contains passive electronics to create a low pass filter and any connector interfaces (e.g., first data connector 340 and first filter connector 344). The filter 318 comprises resistors and series inductors, which act as a low pass filter A wiring harness 328 is and is used to electrically connect the connectors 314, 316 to one another and to the filter 318 via the PCB 317. In one example, the PCB 317 is secured to a cover 313, which may include vibration isolators 366 that engage one or more features of the PCB 317. A cover is arranged between the first and second housing portions and is secured to one of the first and second housing portions over the PCB to seal the PCB. The cover 313 includes a seal 368 and is secured to the first housing portion 312a, for example, using an arrangement of fasteners 319 and/or cooperating tabs 321 and slots 323. Thus, costly, time-consuming potting can be avoided.

The second housing portion 312b is secured to the first housing portion 312a over the cover 313. A gasket 370 may be provided on one side of the second housing portion 312b to seal against the first housing portion 312a and/or the cover 313. Another gasket 372 may be provided on the opposite side of the second housing portion 312b to seal the integrated connector filter 310 relative its respective truck or trailer. An opening 336 (FIG. 9B) may be provided in the second housing portion 312b for receiving an end of wires 320 (FIG. 10) during installation.

The cover 313 or PCB 317 provides a first data connector 340 (FIG. 11) electrically connected to the filter 318 in the housing 312. A second data connector 342 (FIG. 10) is provided by the wiring harness 328 such that it is electrically connected to the electrical paths 324 from the wiring harness 328, and is connected to the first data connector 340 (FIG. 11). A first filter connector 344 (FIG. 11) is provided by the cover 313 or PCB 317 and is electrically connected to the filter 318. A second filter connector 346 (FIG. 10) is provided on the wires 320 (from its gateway, either tractor or trailer, depending upon integrated connector filter installation location) and connected to the filter 318 via the first data connector 344 (FIG. 11). Thus, the filter 318 is electrically interposed between the first data and filter connectors 340, 344 to superimpose the signal onto the at least one wire 324 and/or split off the signal from the at least one wire 324 carrying the signal to/from the gateway via the wire(s) 320, while the remaining electrical paths 326 of the wiring harness 328 pass their respective signals directly between the female and male connectors 314, 316.

It should be understood that one or more of the connectors 330, 332, 340, 342 may be eliminated by hardwiring (e.g., soldering or other connection) the wire(s) 324, 326 to its respective component, as the wiring harness 328 is internal to the housing 312. However, doing so may increase assembly time of the integrated connector housing and reduce its serviceability. The connectors 344, 346 may also be eliminated by hardwiring, but this would require a more cumbersome installation of the integrated connector filter onto the vehicle in order to connect the integrated connector filter the tractor's or trailer's gateway.

A method of installing the integrated connector filter includes the steps of removing a standard (e.g., J560) connector from a tractor or trailer socket provided on its wiring harness. A second filter connector from the tractor or trailer gateway is connected to the first filter connector provided on the integrated connector filter, and the integrated connector filter's (male) connector is coupled to the tractor or trailer socket. Fasteners provided on the integrated connector filter are tightened to secure the housing to the tractor or trailer socket. The cable (e.g., J2394) used to electrically connect the tractor and trailer to one another is coupled to the other connector on the integrated connector filter. This installation can be performed by an operator in a matter of minutes.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers on method claim steps are for ease of reference in dependent claims only and do not signify a required sequence of steps unless other explicitly recited in the claims.

1. An integrated connector filter for adapting a tractor or a trailer to communicate data over tractor/trailer cable, comprising:
a housing providing first and second connectors in electrical communication with one another, the first connector configured to be removably connected to a cable electrically connecting the tractor and the trailer to one another, the second connector configured to be connected to one of the tractor and the trailer;
a filter arranged within the housing and electrically connected between the first and second connectors by at least one wire; and
a first filter connector electrically connected to the filter and configured to carry a signal, wherein the filter is configured to superimpose the signal onto the at least one wire and/or split off the signal from the at least one wire, and wherein the first filter connector is configured to be electrically connected to a gateway on one of the tractor and the trailer.

2. The integrated connector filter of claim 1, comprising a PCB including the filter, wherein the housing includes first and second housing portions, the PCB is mounted to one of the first and second housing portions.

3. The integrated connector filter of claim 2, comprising a cover is arranged between the first and second housing portions, wherein the cover is secured to the one of the first and second housing portions over the PCB to seal the PCB.

4. The integrated connector filter of claim 2, comprising a wiring harness arranged within the housing and electrically connecting the first and second connectors to one another and to the filter via the PCB.

5. The integrated connector filter of claim 4, comprising a first data connector provided on the PCB or the housing, the first data connector electrically connected to the filter, wherein the wiring harness includes the at least one wire terminating in a second data connector electrically connected to the first data connector, wherein the filter is electrically interposed between the first data connector and the first filter connector.

6. The integrated connector filter of claim 3, wherein the wiring harness includes first and second pinned connectors removably connected respectively to a backside of the first and second connectors.

7. The integrated connector filter of claim 1, wherein the first connector is a female connector and the second connector is a male connector.

8. The integrated connector filter of claim 7, wherein the first and second connectors are each 7-pin connectors.

9. The integrated connector filter of claim 8, wherein the 7-pin connectors are compatible with standard J560 connectors.

10. The integrated connector filter of claim 1, wherein the first connector is removably secured and electrically coupled to the housing.

11. The integrated connector filter of claim 10, wherein the first connector is a standard 7-pin female J560 connector.

12. The integrated connector filter of claim 2, wherein the second housing portion includes an opening configured to receive gateway wires for connection to the first filter connector.

13. A tractor comprising the integrated connector filter of claim 1, comprising:
a CMS including first and second rear-facing cameras, at least one display, and a CMS controller in communication with the first and second rear-facing cameras and the at least one display, the CMS controller configured to provide video feeds from the first and second rear-facing cameras to the at least one display;
vehicle controls configured to operate trailer components;
a wiring harness electrically connected to the vehicle controls and terminating at a bulkhead connector, the integrated connector filter of claim 1 electrically connected to the bulkhead connector;
another controller including at least one processor and the gateway, the other controller configured to receive a sensor signal from a sensor on the trailer and to receive control signals for controlling the trailer components, the at least one processor configured to transform the sensor signal for transmission over the wiring harness with at least one of the plurality of control signals using common wires within the wiring harness.

14. A trailer comprising:
multiple trailer components;
a sensor configured to generate a sensor signal;
a wiring harness electrically connected to the multiple trailer components and the sensor, the wiring harness terminating at a bulkhead connector, the integrated connector filter of claim 1 electrically connected to the bulkhead connector;
a controller including at least one processor and the gateway, the controller configured to receive the sensor signal from the sensor and to receive control signals for controlling the trailer components, the at least one processor configured to transform the sensor signal for transmission over the wiring harness with at least one of the plurality of control signals using common wires within the wiring harness.

15. A method of installing the integrated connector filter of claim 1, comprising the steps of:
a) removing a standard connector from a tractor or trailer socket at a bulkhead;
b) connecting a second filter connector from the tractor or trailer to the first filter connector;
c) inserting the first connector into the tractor or trailer socket;
d) tightening fasteners to secure the housing to the tractor or trailer socket; and
e) inserting a cable into the second connector to couple the tractor and trailer to one another.
